(19) United States
(12) Patent Application Publication
(10) Pub. No.: US 2013/0256294 A1
(43) Pub. Date: Oct. 3, 2013

(54) DEVICE FOR HEATING WATER FOR A COMBINATION SHOWER-WC

(71) Applicants: Hans Wurgler, Heerbrugg (CH); Paul Oehy, Diepoldsau (CH); Daniel Graber, Oberriet (CH)

(72) Inventors: Hans Wurgler, Heerbrugg (CH); Paul Oehy, Diepoldsau (CH); Daniel Graber, Oberriet (CH)

(73) Assignee: PRESANO AG, Diepoldsau (CH)

(21) Appl. No.: 13/880,046

(22) PCT Filed: Oct. 19, 2010
(86) PCT No.: PCT/CH2010/000260

§ 371 Date: May 22, 2013

(51) Int. Cl. E03C 1/044; G05D 23/19; E03D 9/00; A47K 4/00

(52) U.S. Cl. CPC E03C 1/044; A47K 4/00; G05D 23/19; E03D 9/002
USPC 219/441; 392/451; 219/494

(57) ABSTRACT

Device (1) for heating water for a combination shower-WC having a shower arm to which the water can be supplied by means of a pump, said device comprising a tank (2) for holding water, and a heating mechanism which heats the water held in the tank (2), wherein the device (1) is arranged in a structural unit (3) for connection between a water supply and the shower arm of the combination shower-WC, and the heating mechanism comprises a bottom-mounted heating element (4) which at least partially forms a boundary of tank (2).

The present invention relates to a device for heating water for a combination shower-WC.

A combination shower-WC is a combination of a toilet and a bidet, which makes anal and/or vulvar hygiene with water possible. Complete combination shower-WCs and combination shower-WC attachments which are mounted on conventional WC bowls are known.

Combination shower-WCs are known in various designs. In general, the combination shower-WC has a shower arm which can be extended and/or swiveled into the WC bowl. The shower arm is connected to a domestic hot water tank. Warm water can be supplied by means of a pump from the domestic hot water tank to the shower arm. An additional element of the combination shower-WC is, in general, a blow-drying arm. The air temperature of the blow-dryer can be regulated, and its function can be switched on and off. The actuation of the shower arm and of the blow-drying arm occurs by means of a combination shower-WC control unit which is operated via an operating surface comprising one or more switches or buttons, which is generally arranged on the side of the WC bowl for the purpose of good accessibility, or which can be operated by remote control.

In a combination shower-WC it is important to take into account both the convenience during the operation of the shower arm with a preselected water temperature and also the possibility of cleaning the water conveying and water containing tanks and passages from the water source to the shower arm, in order to guarantee hygiene and to kill any germs present.

From CN 2493217 Y, a device is known for generating a constant warm water temperature and automatic disinfection.

From JP 7067245 A, a safety unit for a voltage supply circuit in a shower toilet or a hot water cleaning system is known, for the purpose of preventing the overheating of an incorrectly contacting plug. A current interrupter interrupts the current based on the data of a temperature sensor.

From JP 2009 034 593 A, a cleaning system based on an electrolyte system is known, which comprises an intermediate chamber for receiving an aqueous electrolyte solution, which is arranged between an anode chamber and a cathode chamber, wherein the chambers are separated by membranes.

From CN 2923683 Y, a disinfection-deodorizing system is known which comprises an air ionization pipe which is connected to a high-frequency high-voltage generator.

From JP 4339934 A, a cleaning device for a heated toilet seat is known, in which electrolysis is used. An acid is used for cleaning, and a base for rinsing.

From S19400279 A, a cleaning device for cleaning a toilet seat is known, in which the steam or hot water used is pressurized.

From JP 2001 214 501 A, toilet seat with hot water cleaning is known, which comprises a water cleaning device arranged in a passage that extends from the water heater to the water nozzle.

From CN 2746872 Y, a multifunctional hygiene device is known, in which a hot air flow and hot water are used for disinfection.

From DE 42 36 238 A1, a device for killing pathogenic germs in the anti-syphon traps of sanitary fixtures is known, in which a spray head is arranged in the anti-syphon trap, by means of which disinfectant can be filtered into the liquid content of the siphon, and reach the remaining surfaces above the liquid level in a targeted manner.

From EP 0 035 471 B1, a WC installation is known, in which a bowl arrangement made of two nearly identical bowls is used, which can be exchanged around a common rotation axis. For the purpose of killing germs, a disinfectant and a drying agent are used.

The proposed solutions are expensive and/or do not lead to acceptable results with regard to the disinfection and cleaning of the tank and/or of the water conveying lines and tanks from a water source or water supply line to the shower arm.

The aim of the invention is to produce a device for heating water for a combination shower-WC, which overcomes the above-mentioned disadvantages.

The aim is achieved with the device according to the characteristics of Claim 1.

In this manner, a device for heating water for a combination shower-WC is produced, which comprises a shower arm which can be supplied with water by means of a pump. The device contains a tank for holding water and a heating device which heats the water held in the tank. Because the device is arranged in a structural unit for connection between a water supply and the shower arm of the combination shower-WC, a simple possibility for adaptation to existing systems is given, wherein, due to the fact that the heating device has a bottom-mounted heating element which at least partially forms a boundary of the tank, a homogeneous heating of all the water in the tank is possible, which can also be used to kill any germs present in the water by heating. Thanks to the bottom-mounted heating element, it is ensured that there are no unheated zones (so-called dead zones) in the water of the tank. By thermal disinfection, any germs that may be present anywhere in the entire water conveying system from the tank to the shower arm are destroyed or their number is considerably decreased. When heating the water in the tank, no layering develops, which, for example, leads to the water being warmer in the top region of the tank than in the bottom region. Any change in the temperature when using the shower arm is ruled out. The entire volume in the tank that has been filled with water can be used, since the heating element is located at the lowermost position around the tank, which allows a uniform heating of all the water in the tank. The device, which is designed as a structural unit, allows rapid access to the heating device during mounting and/or maintenance.

Furthermore, the tank can be designed in the form of a case, in order to allow a compact shape, wherein an appropriate adaptation of the outer contour of the structural unit to an outer contour, for example, of the ceramics of the WC, can be achieved.

Furthermore, the heating element can be a bottom-mounted closing end piece of the tank, in order to be able to heat all the water contained in the tank uniformly, which reduces the dead volume (zones with unheated water) to nearly zero. Furthermore, the heating element can be a bottom-mounted closing end piece of the tank, which is attached by a releasable plug or screw connection to the upper section of the tank. As a result, a compact device is produced, by means of which, in the case of a defect and/or for maintenance, a simple exchange of the heating element can be carried out.

Furthermore, to rule out any hazard for a person that uses the combination shower-WC, two temperature sensors are provided in or on the tank, the signal of which can be acquired independently of each other. The temperature acquisition thus occurs redundantly. Here, it is also possible to provide that, if a discrepancy between the temperatures detected by the two temperature sensors is noticed, the function of the shower arm can be switched off.

Furthermore, to further increase safety with regard to the hazards to which a person using the combination shower-WC is exposed as a result of excessively hot water, the processing of the two temperature sensors can be such that a control with a microprocessor and a separate circuit arrangement is possible, wherein the signal of one of the two temperature sensors can be acquired by the microprocessor, and the signal of the other of the two temperature sensors can be acquired by a separate circuit arrangement. Thus, it becomes possible not only to detect an error of a temperature sensor, but also to determine whether one of the elements performing the processing, i.e., here an element of the microprocessor and of the separate circuit, has a malfunction.

Furthermore, for a simplified reliable decontamination by thermal disinfection, a control unit can be provided, which is designed to prevent the release of the hot water to a user of the combination shower-WC, at the time when a cleaning function or decontamination function of the tank and of the water conveying lines up to the shower arm with water heated above 60° C., particularly water heated to approximately 70° C., is carried out in the tank. The control unit for the determination of the temperature of the two temperature sensors can be the same control unit as the control unit used to prevent a discharge of water in the case of the performance of a disinfection function; the control units are then implemented physically in the same control unit.

Furthermore, on the structural unit or on the tank, a closable filling opening for supply from the outside can be provided, for the introduction of a decalcification agent, in order to provide a particularly high level of convenience in the maintenance of the combination shower-WC.

Furthermore, with a view to a decalcification, a control unit can be provided by means of which a decalcification process can be carried out after the introduction of a decalcification agent. The decalcification then occurs automatically. Moreover, it is particularly preferable that the control unit for controlling the decalcification process is the same as the control unit for the acquisition of the temperature and for carrying out the disinfection function.

To achieve a particularly high level of convenience during the use of the combination shower-WC with a view to large quantities of uniformly heated water for anal and/or vulvar hygiene, the ratio of the height extent to the side extent of the tank can be selected to be greater than two. It is particularly preferable for the ratio of the extent of the tank in the direction of the height and the extent perpendicular to said height to have a value greater than three.

It is possible to provide that the structural unit 3 with the device according to the invention is accommodated in a technical unit, which comprises a front interface for mounting on a closet body and a rear interface for mounting on a building-side installation surface.

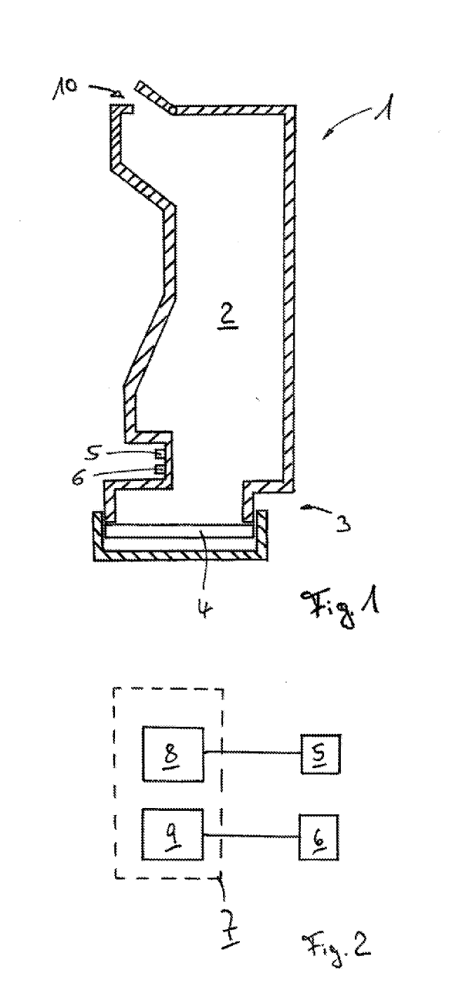

FIG. 1 diagrammatically shows a device according to the invention in a side view; and

FIG. 2 diagrammatically shows a block diagram of a control unit, which is connected to the device according to FIG. 1 and to a shower arm of a combination shower-WC, and which represents a variant of the device according to the invention of FIG. 1.

FIG. 1 diagrammatically shows a device 1 for heating water for a combination shower-WC—not shown—which comprises a shower arm for intimate hygiene. The water which is heated in the device 1 shown in FIG. 1 can be supplied to the shower arm of the combination shower-WC by means of a pump which is not shown.

The device 1 according to the invention shown in FIG. 1 comprises a tank 2 for holding water and a heating device. By means of the heating device, the water held in the tank 2 can be warmed or heated.

The device 1 is arranged in a structural unit 3 which can be formed in the shape of a case, and it can be arranged between a water supply and the shower arm of the combination shower-WC. For this purpose, in the tank 2, an opening is provided for supplying water or for filling the tank with water from the water supply, for example, the line network. Furthermore, an opening for removing the heated water by means of a pump and for conveying the water to the shower arm of the combination shower-WC in the tank 2 is provided.

The heating device comprises a bottom-mounted heating element 4 located on the tank 2. The heating element 4 can form at least partially a boundary of the tank 2, in which the heating element 4 forms the bottom of the tank 2. The heating element 4 forms the lowermost surface of the tank 2, and the water is filled in above the heating element 4 in contact with the latter in the tank 2. The bottom of the tank 2 is configured as a heating unit. The heating element 4 is arranged in a bottom-mounted closing end piece of the tank 2.

The heating element 4 is arranged in a lowermost position in a closing end piece of the tank 2 in a lower section of the structural unit 3. The bottom section with the closing end piece of the tank 2 can be coupled or connected to an upper section of the structural unit 3, in the form of a releasable plug or screw connection. The screw or plug connection occurs with formation of a seal between the two sections with respect to the water that can be filled into the tank 2. In the lower section, the electrical supply lines for the heating element 4 can be formed or extend. The two sections form the tank 2 in the interior.

In the tank 2, two temperature sensors 5, 6 are provided. The signal of the temperature sensors 5, 6 or temperature detectors can be acquired independently of each other. The temperature sensors 5, 6 can be attached to the tank 2 itself or to the structural unit 3. The temperature sensors 5, 6 can protrude through the sealed perforations into the tank 2. Alternatively, the temperature sensors 5, 6 can be arranged on an outer tank wall of the tank 2.

According to FIG. 2, a control unit 7 according to an embodiment example is provided, which contains a microprocessor 8 and a separate circuit arrangement 9. The signal of one of the two temperature sensors 5 can be acquired by the microprocessor 8. The signal of the other of the two temperature sensors, that is to say of the temperature sensor 6, can be acquired by the separate circuit arrangement 9, which contains in particular a Schmitt trigger as structural unit for switching off when a certain limit value has been reached. The signal of the temperature sensors 5, 6 can be processed by the control unit 7. The control unit 7 can be designed as an additional control unit for controlling the other units of the combination shower-WC, or, on the other hand, the control unit 7 and the control unit for the other functions of the combination shower-WC are designed as one control unit 7.

The control unit 7 is also configured to prevent the release of water to a user, when a cleaning function or disinfection function or decontamination function with water heated above 60° C., particularly water heated to approximately 70° C., is carried out in the tank 2, which is detected by the temperature sensors 5, 6.

At the time of the disinfection function or decontamination, the water is heated to approximately 70° C., which is detected by the temperature sensors 5, 6, and, after an action time, the content of the tank 2 is slowly pumped out, wherein the subsequent system (not shown) of hoses, pump, valves and shower arm, is also cleaned with hot, decontaminated water. The control unit 7 ensures that a user of the combination shower-WC is not scalded with hot water. A hazard to the person is ruled out. The use of water that has been heated in this manner is not possible for a “normal” function of the shower arm.

The device 1 comprises on the head side on the tank 2 a closable filling opening 10 for supply from the outside. The closure of the filling opening 10 can be implemented as a hinged, a bayonet or a sliding closure. Through the filling opening 10, the introduction of decalcification agent from the outside is possible. The control unit 7 is designed in such a manner that a decalcification process can be carried out after the introduction of the decalcification agent. In the microprocessor 8, a corresponding program can be carried out, which has the effect that, after an action time that is preset in the program, a controlled emptying of the tank 2 and of the subsequent system (not shown), for example, hoses, a pump, valves and a shower arm, occurs, as a result of which the subsequent system is also decalcified. The water cannot be used during this time, which protects the user from contact with the decalcification agent.

As shown in FIG. 1, the ratio of the height extent of the tank 2 to the side extent of the tank 2 is greater than two, in particular greater than three.

As described above, the present invention allows a simple possibility for adaptation to existing combination shower-WC systems, wherein a homogeneous heating of all the water in the tank for use with the shower arm is possible. However, the homogeneous heating can also be used to kill any germs present in the water by heating. By means of thermal disinfection, any potentially present germs in the water conveying system, from the tank to the shower arm, can be destroyed or their number can be considerably decreased. The structural unit allows rapid access to the heating device during mounting and/or maintenance. Due to the possibility of the thermal disinfection, the maintenance of the combination shower-WC is also simplified.

1. A device for heating water for a combination shower-WC, which comprises a shower arm to which the water can be supplied by means of a pump, and which comprises a tank for holding water and a heating device which heats the water held in the tank, wherein the device is arranged in a structural unit for connection between a water supply and the shower arm of the combination shower-WC, and the heating device comprises a bottom-mounted heating element, and wherein the heating element is a bottom-mounted closing end piece of the container.

2. The device according to claim 1, wherein the tank is in the shape of a case.

3. The device according to claim 1, wherein the heating element forms at least partially a boundary of the tank.

4. The device according to claim 1, wherein the bottom-mounted closing end piece of the tank is attached by a releasable plug or screw connection to an upper section of the tank.

5. The device according to claim 1, wherein, on the tank, two temperature sensors are provided, the signal of which can be acquired independently of each other.

6. The device according to claim 5, wherein a control unit with a microprocessor and with a separate circuit arrangement is provided, and the signal of one of the two temperature sensors can be acquired by the microprocessor, and the signal of the other of the two temperature sensors can be acquired by the separate circuit arrangement.

7. The device according to claim 6, wherein the control unit is designed to prevent the release of the water to a user, when a cleaning function with water heated above 60° C. is carried out in the tank.

8. The device according to claim 1, wherein the tank comprises a closable filling opening for supply from the outside decalcification agents.

9. The device according to claim 16, wherein a control unit is provided, by means of which a decalcification process can be carried out after the introduction of the decalcification agent.

10. The device according to claim 1, wherein the ratio of height extent to side extent of the tank is greater than two.

11. Use of the device according to claim 1 for heating water for a combination shower-WC.

12. A structural unit with a device according to claim 1, wherein the structural unit comprises a connection to a water supply and a connection to the shower arm of a combination shower-WC.

13. The structural unit according to claim 12, wherein it is accommodated in a technical unit which comprises a front interface for mounting onto a closet body and a rear interface for mounting onto a building-side installation surface.

14. The structural unit according to claim 12, wherein it is connected to a shower arm of a combination shower-WC.

15. The device according to claim 6, wherein the control unit is designed to prevent the release of the water to a user, when a cleaning function with water heated to approximately 70° C. is carried out in the tank.

16. The device according to claim 1, wherein the tank comprises a closable filling opening for supply from the outside of decalcification agents.
